(19) United States
(12) Patent Application Publication
(10) Pub. No.: US 2026/0234752 A1
(43) Pub. Date: Aug. 13, 2026

(54) Heap Leaching a Material

(71) Applicant: Rio Tinto Technological Resources Inc., South Jordan, UT (US)

(72) Inventors: Ronald Sorensen, South Jordan, UT (US); John Richard Meloy, South Jordan, UT (US); Ralph Peter Hackl, Melbourne (AU); Paul Leslie Brown, Melbourne (AU); Mark James Fennel, South Jordan, UT (US)

(21) Appl. No.: 19/153,207

(22) PCT Filed: Feb. 2, 2024
(86) PCT No.: PCT/US2024/014128

§ 371 Date: Aug. 1, 2025

Related U.S. Application Data
(63) Continuation-in-part of application No. 18/105,514, filed on Feb. 3, 2023.

(30) Foreign Application Priority Data
Feb. 3, 2023 (AU) 2023200579

(51) Int. Cl. C22B 15/00; C22B 3/08; C22B 3/18

(52) U.S. Cl. CPC C22B 15/0071; C22B 3/08; C22B 3/18

(57) ABSTRACT

A method of heap leaching a metal from a ROM material that contains a metal sulfide-containing material, such as a copper sulfide-containing mineral. The method comprises forming a heap of the ROM material or extending an existing heap by adding the ROM material to the heap. The method also comprises leaching the metal from the ROM material in the heap with an acidic leach liquor and producing a pregnant leach liquor containing the metal in solution and recovering metal from the pregnant leach liquor. Pyrite that is already in the ROM material generates acid and heat that facilitates leaching metal from the ROM material. The ROM material may be transferred directly from the mine to the heap without changing the size of material particles in the ROM material. The method may comprise adding additional pyrite and other additives to facilitate leaching metal.

### CROSS-REFERENCE TO RELATED APPLICATION

This application claims priority to Australia Patent Application No. 2023200579 filed Feb. 3, 2023 and U.S. application Ser. No. 18/105,514, filed Feb. 3, 2023.

### TECHNICAL FIELD

The present invention relates to a method of heap leaching a metal, such as copper or nickel or zinc or cobalt, from a run-of-mine (“ROM”) material that contains a metal sulfide-containing material, such as a metal sulfide mineral, and recovering the metal from the material.

The metal-containing material may be an ore.

The metal-containing material may be a waste material, such as tailings or mineralised waste that is uneconomic to process using the current processes employed at the mine from which the mineralised waste was mined.

The invention relates particularly to heap leaching a run-of-mine (“ROM”) material, i.e. material that has been mined and then transferred to a heap of material without further size reduction being carried out on the material beyond that occurring during mining the material, as described further below, and optionally transferred to the heap via a treatment station(s), for example for adding microbes or other additives to the ROM material.

The present invention also relates to a heap leaching operation.

The present invention also relates to a method of mining a ROM material and heap leaching the material.

### BACKGROUND ART

The technical field of the invention is the production of a metal, such as copper or nickel or zinc or cobalt, from a metal sulfide-containing material, such as a metal sulfide mineral, from run-of-mine (“ROM”) material.

The following description of the invention focuses on copper as one example of a metal in a metal sulfide-containing material, such as a metal sulfide mineral.

Copper is an increasingly important metal for the transition to a low carbon-based global economy.

There are substantial capital and operating cost pressures on mine operators of well-established and new copper mines (which term includes mines in which copper is the only metal recovered and mines in which copper and other valuable metals such as gold are recovered) that have lower average concentrations of copper in copper sulfide-containing materials, such as copper sulfide-containing minerals, than was previously the case.

In many instances, the problem of lower copper concentrations in copper sulfide-containing materials, such as copper sulfide-containing minerals, is compounded by the copper being in increasingly higher proportions of more refractory copper sulfide-containing minerals, such as chalcopyrite, than was the case previously, with these minerals being more difficult and expensive to process to recover copper from the minerals.

Mining companies are also very conscious of the importance of operating mines with minimal environmental impact over short and longer terms and this has an impact on recovery options and costs.

The economics facing copper mine operators mean that there are substantial amounts of copper sulfide-containing material, including mined material and processed forms of mined material (e.g., comminuted material), that are non-economic to recover copper from using recovery options available before the invention was made and therefore are not processed to recover copper from copper sulfide-containing material.

The above description is not an admission of the common general knowledge in Australia or elsewhere.

### SUMMARY OF THE DISCLOSURE

The invention was made as part of a research and development project of the applicant on leaching copper from copper sulfide containing material, particularly copper sulfide minerals.

The research and development project is focused particularly, although not exclusively, on leaching copper from chalcopyrite (CuFeS₂), hereinafter referred to as “chalcopyrite materials”, because it is known that it is difficult to obtain high copper recoveries from chalcopyrite materials and chalcopyrite materials are a significant source of copper.

The research and development project has produced a number of inventions, some of which are summarised below:
1. International Applications PCT/US2021/043869 (WO 2022/026810) and PCT/US2021/043869 (WO 2022/026826). The specifications disclose the impact of pyrite augmentation on bioleaching of an agglomerated copper-containing mined material
2. International Applications PCT/AU2016/051024 (WO2017/070747) and PCT/AU2018/050316 (WO 2018/184071). The specifications disclose the impact of silver augmentation on bioleaching of an agglomerated copper-containing mined material. The specification of International Application PCT/AU2018/050316 (WO 2018/184071) also discloses an activation agent that activates silver whereby the silver enhances copper extraction from copper-containing mined material.
3. International Application PCT/AU2019/050383 (WO2019/213694). The specification discloses the impact on the dissolution of copper from copper minerals in copper-containing mined material or concentrates of the material of additives (such as thiourea) that form complexes between (a) sulfur, that originated from copper minerals in the materials, and (b) the additives.

The disclosures in the patent specifications of the above International Applications are incorporated herein by cross-reference.

Further work in the research and development project has recognized that a method of heap leaching a run-of-mine (“ROM”) material as described herein is a viable opportunity that has a number of important advantages.

Heap leaching ROM material in accordance with the invention is a different approach to heap leaching agglomerates of mined material that is the focus of the above International Applications.

The ROM material may be an ore or a waste material.

The term “ore” is understood herein to mean natural rock or sediment that contains one or more valuable metals that can be mined, reclaimed, treated and sold at a profit. It is noted that the term “ore” is a relative term in that a material may be regarded as an ore, i.e., profitable at one point in time and a waste material at another point in time. It is also noted that an assessment of whether a material is an “ore”, i.e., profitable, can also be dependent on the mine from which the material is mined and the capital and operating costs in the mine, including whether the mine is a brownfield or greenfield mine.

The ROM material may be obtained from any mining operation in a mine.

For example, the mining operation may be a drilling and blasting operation in an open pit mine, with the ROM material being rocks that form when a mine bench is drilled and blasted.

By way of further example, mining operation may be an operation involving the use of a continuous miner, with the ROM material being rocks that are produced from the continuous miner.

By way of further example, the mining operation may be a block caving operation in an underground mine, with the ROM material being rocks in rill piles at draw points of a block cave.

In broad terms, the invention provides a method of heap leaching a metal from a run-of-mine (“ROM”) material, as described herein, from a mine that contains a metal sulfide-containing material, such as a metal sulfide mineral, that comprises:
(a) forming a heap of the ROM material or extending an existing heap by adding the ROM material to the heap; and
(b) leaching the metal from the ROM material in the heap with an acidic leach liquor, with pyrite already in the ROM material generating acid and heat that facilitate leaching the metal from the ROM material and producing a pregnant leach liquor containing the metal in solution.

The term “ROM material” is understood herein to mean rocks of material that form in a mining operation and are transferred from the mine:
i. directly to the heap; or
ii. directly to a stockpile and then transferred later directly to the heap.

The term “ROM” material includes rocks produced when large rocks of ROM material that are too large to be transported from mines have been broken down, for example by rock breakers.

The term “rock breaker” is understood herein to mean a “machine designed to manipulate large rocks, including reducing large rocks into smaller rocks”, which is distinct from a crusher.

The term “ROM” material includes ROM material that has been separated into fractions based on size.

In both cases where there has been rock breaking and/or size separation, the resultant material is ROM material.

The method may also comprise collecting the pregnant leach liquor from the heap and recovering the metal from the pregnant leach liquor.

The method may comprise recovering the metal from the pregnant leach liquor by any suitable recovery options.

The recovery method may comprise extracting the metal from the pregnant leach liquor with a solvent and producing a metal-containing solvent stream and a raffinate.

The recovery method may comprise stripping the metal from the solvent and forming a metal-containing solution and electrowinning the metal from the metal-containing solution.

The method may also comprise transferring the raffinate to the leach step (b).

The method may comprise adding additional material (additives) to the ROM material before the heap is formed, as the heap is being formed, or after the heap has been formed, or to the leach liquor.

The additional material (additives) may be additional pyrite.

For example, heap forming step (a) may comprise forming the heap of the ROM material with additional pyrite to that in the ROM material or extending an existing heap by adding the ROM material and additional pyrite to that in the ROM material to the heap.

The method may comprise adding additional pyrite to the heap, such as to a top of the heap during the course of the heap leaching step (b).

The method may comprise adding additional pyrite to the ROM material before forming the heap in heap forming step (a).

Pyrite is important for acid generation and heat generation.

Pyrite generates heat within the heap via reactions in the heap, including reactions with the leach liquor.

It is desirable to reach a target heap temperature quickly to generate cash flow. It is also desirable to maintain a substantially constant heap temperature with time. Temperature variations can have an impact on copper extraction rates and microbe health (in situations where microbes are in a heap).

Typically, higher heap temperatures produce higher copper extraction rates.

When microbes are in a heap, microbe health may be impacted by temperatures above or below a target temperature range and, therefore, it is important to take this into account when selecting a target heap temperature.

The method may comprise selecting the amount of additional pyrite for the heap to reach a target temperature quickly, i.e., in ≤500 days, more typically in ≤400 days, and more typically in ≤300 days.

The target temperature will depend on a range of factors in any given situation.

These factors may include any one or more than one of the type of microbes, material mineralogy, material grade (e.g., the concentration of a metal in the material or the concentration of contaminant(s) in the material), acid dose rates, and pH of the leach liquor, etc. The target temperature, expressed as an average heap temperature, may be in a range of 60-80° C.

The term “average” temperature is understood herein to take into account that there may be temperature variations through a heap and therefore an average temperature of, say 70° C., takes into account that there may be a different temperature in one part of a heap to the temperature in another part of the heap and the average temperature is the average of a number of temperature measurements in the heap.

In general, the method may comprise adding additional pyrite to the ROM material in or at any one or more of:
(a) a location at which the ROM material forms in a mining operation (for example slumped material that forms after a mine bench is drilled and blasted),
(b) a location where ROM material is loaded onto haul vehicles (such as haul trucks or load-haul-dump vehicles) or conveyors or any other transport options, with additional pyrite being added with or after the ROM material is add onto the transport options,
(c) as the ROM material is being transported from a loading location(s) in the mine to a heap, a stockpile, or an intermediary station, or from the stockpile or the intermediary station to the heap,
(d) as the ROM material is being added to the heap,
(e) at an intermediary station located between the loading location(s) and the heap,
(f) at an intermediary station located between the stockpile and the heap,
(g) in a blending operation comprising blending together the ROM material and additional pyrite and then adding the blend to the heap,
(h) in the stockpile, and
(i) in the heap, for example in the leach liquor or directly as a separate additive as the heap is being formed or after the heap has been formed, such as to a top of the heap during the course of the heap leaching step.

The term “intermediary station” is understood herein to include fixed storage facilities such as sheds, or mobile transport vehicles (e.g., for the transfer of the ROM material from truck to train) that receive the ROM material any time between the loading location(s) and the heap.

Typically, the ROM material contains pyrite.

The total pyrite, i.e., the total of the pyrite in the ROM material and the additional pyrite, may be 1-10 wt. %, typically 1-6 wt. %, and more typically 1-5 wt. %, of the total mass of the ROM material and the additional pyrite.

The additional pyrite may be obtained from any suitable source.

The additional pyrite may be in any suitable form, noting that an important consideration is whether the pyrite is in a form that can react beneficially in the heap.

The pyrite may be in the form of a pyrite concentrate.

The method may comprise sourcing the additional pyrite from the mine or another mine.

The method may comprise sourcing the additional pyrite from tailings from a tailings dam or a material processing plant (such as cleaner scavenger tails from a concentrator circuit) of the mine or another mine.

The method may comprise selecting the amount of the added pyrite to be below a threshold total pyrite concentration for the pyrite in the material and the additional pyrite.

The threshold total pyrite concentration may be in a range of 1-10 wt. %, typically 1-6 wt. %, and more typically 1-5 wt. %, of the total of the ROM material and additional pyrite. The selection of the threshold total pyrite concentration in any given situation will depend on a range of factors. For example, if the ROM material contains a lot of secondary metal sulfides and is located in a warm/hot climate, the threshold total pyrite concentration may be at or towards the lower limit of 1 wt. %.

There may be situations where there is enough pyrite in the ROM material to make pyrite concentrate addition unnecessary.

For example, if the ROM material already contains the required threshold total pyrite concentration, there may be no need to add additional pyrite. However, additional pyrite may be added in this situation to enable a target temperature to be reached more quickly than would otherwise be the case. This would particularly be the case in situations where the additional pyrite has a fine particle size and is therefore readily able to react.

The additional material (additives) may be microbes for oxidising ferrous ions and oxidising solid and soluble sulfur compounds, thereby regenerating ferric ions and acid and generating heat.

The microbes may be any suitable microbes.

The microbes may be any microbes that can oxidise ferrous iron and/or sulfur compounds and include, but are not limited to, members of the bacterial genera Acidithiobacillus, Leptospirillum, Sulfobacillus and Ferrimicrobium, and the archaeal genera Acidianus, Acidiplasma, Ferroplasma, Metallosphaera and Thermoplasma.

Typically, the microbes are a diverse population, including microbes selected from mesophiles, moderate thermophiles and psychrotolerant or mesophilic or thermophilic (moderate or extreme) bacteria or archaea. The microorganisms may be acidophilic bacteria or archaea. The microorganisms may be thermophilic acidophiles. A diverse population allows activity across a range of operating conditions, including low pH conditions, high sulfate concentrations, and a wide temperature range of, say, 5-80° C.

The method may comprise adding other additives (in addition to microbes and pyrite described above) to the ROM material to enhance metal extraction from the heap before the heap is formed, as the heap is being formed, or after the heap has been formed, or to the leach liquor.

In a situation where the metal is copper, the other additives may comprise silver, such as in the form of silver chloride, silver nitrate or silver sulfate. As noted above, International Applications PCT/AU2016/051024 (WO2017/070747) and PCT/AU2018/050316 (WO 2018/184071) disclose the impact of silver augmentation on bioleaching of a copper-containing mined material.

In a situation where the metal is copper, the other additives may comprise an activation agent to activate silver, selected from thiourea, chlorides, bromides and iodides. As noted above, International Application PCT/AU2018/050316 (WO 2018/184071 discloses activation agents that activate silver whereby the silver enhances copper extraction from copper-containing mined material.

In a situation where the metal is copper, the other additives may comprise a complexing agent (such as thiourea and carbamide phosphate—as disclosed in U.S. Pat. No. 3,679,397, the entire disclosure of which is incorporated into the specification) to enhance the dissolution of copper by forming complexes between (a) sulfur, that originated from copper minerals in the copper-containing mined material, and (b) the complexing agent. As noted above, International Application PCT/AU2019/050383 (WO2019/213694) discloses the impact on the dissolution of copper from copper minerals in copper-containing mined material or concentrates of the materials of such additives.

In a situation where the metal is copper, the other additives may comprise chlorides.

The other additives may be added in any suitable way to the heap.

For example, the method may comprise adding the other additives to the ROM material in or at any one or more of:
(a) a location at which the ROM material forms in a mining operation (for example slumped material that forms after a mine bench is drilled and blasted),
(b) a location where ROM material is loaded onto haul vehicles (such as haul trucks or load-haul-dump vehicles) or conveyors or any other transport options, with additional pyrite being added with or after the ROM material is add onto the transport options,
(c) as the ROM material is being transported from a loading location(s) in the mine to a heap, a stockpile, or an intermediary station, or from the stockpile or the intermediary station to the heap,
(d) as the ROM material is being added to the heap,
(e) at an intermediary station located between the loading location(s) and the heap,
(f) at an intermediary station located between the stockpile and the heap,
(g) in a blending operation comprising blending together the ROM material and additional pyrite and then adding the blend to the heap,
(h) in the stockpile, and
(i) in the heap, for example in the leach liquor or directly as a separate additive as the heap is being formed or after the heap has been formed, such as to a top of the heap during the course of the heap leaching step.

In the case of adding chlorides, typically the chlorides are added to the leach liquor, typically in an amount so that the total chlorides in the leach liquor are up to 10 g/l suitably 4 g/l.

The term “total chlorides” is a total of the chlorides that are already in the leach liquor and the additional chlorides added to the leach liquor.

Heap forming step (a) may comprise extending the existing heap by adding the ROM material and additional pyrite to form another vertical lift of the heap.

Heap forming step (a) may comprise extending the existing heap by extending a length or a width of the heap.

Heap forming step (a) may comprise extending the existing heap by adding a lift of new ROM material to the heap to increase the height of the heap.

Heap leaching step (b) may comprise supplying air to the heap via forced aeration.

Heap leaching step (b) may comprise supplying air to the heap via natural circulation of air from outside the heap into the heap.

The leach liquor may be any suitable acidic leach liquor.

By way of example, the acidic leach may be a raffinate in a situation where the metal such as copper is recovered from the pregnant leach liquor in heap leach step (b).

An example of a suitable acid is H₂SO₄.

In a situation where the metal is copper, the method may comprise controlling the acid concentration in the heap to an acid dose rate of less than 100 kg H₂SO₄/dry t material, typically less than 50 kg H₂SO₄/dry t material, typically less than 30 kg H₂SO₄/dry t material and may be less than 10 kg H₂SO₄/dry t material or less than 5 kg H₂SO₄/dry t material. Typically, the acid dose rate is 1-30, more typically 1-20 kg H₂SO₄/dry t material.

The method may comprise monitoring heap parameters selected from any one or more than one of heap temperature, leach liquor irrigation rate (including optional rest rinse cycles), aeration rate, pH of the leach liquor, En of the leach liquor, the population of microbes, copper extraction rate, etc., and adjusting any one or more than one of the parameters to maintain target heap conditions.

The target heap conditions in any given situation will be a function of a number of factors, including ROM material mineralogy, climate conditions, availability and cost of additives, such as additional pyrite, etc.

The metal may be any suitable metal that forms soluble metal sulfate complexes.

Examples of suitable metals are copper, nickel and zinc and cobalt.

When the metal is copper, the metal sulfide-containing material may be a copper sulfide-containing material.

The copper sulfide-containing material may be any suitable copper sulfide-containing material, such as a copper sulfide mineral, such as chalcopyrite.

The ROM material may have any suitable copper grade, i.e., concentration of copper in the material.

By way of example, the ROM material may have an average copper concentration of ≤1.5% by weight (wt. %), typically ≤1.2 wt. %, and more typically ≤1.0 wt. %.

The ROM material may have low copper grades.

The ROM material may have copper grades that are considered to be too low grade to be economically processed in flotation and other wet processing systems for recovering copper from the materials and concentrates of the materials.

The term “low grade” as used in relation to materials containing copper sulfide-containing material is understood herein to be a term that is dependent on currently available technology and the current price of copper, and that material currently considered “low grade” may be considered valuable material in the future depending on technological developments and the future price of copper. The term “low grade” has a similar meaning as applied to nickel and zinc and cobalt mentioned above.

More particularly, the copper sulfide-containing material may be in ROM materials that are too low-grade to be economically processed by any conventional processing method.

By way of context, the term “low concentrations of copper” is understood to mean an average copper concentration of ≤0.9 wt. %, typically ≤0.7 wt. %, typically ≤0.5 wt. %, more typically ≤0.3 wt. %, even more typically ≤0.2 wt. %, even more typically ≤0.1 wt. %.

The ROM material may be in any suitable size for the heap leaching step (b).

For example, the ROM material may have a rock size in a range between a P80 of 200 mm and a P80 of 30 mm, typically in a range between a P80 of 100 mm and a P80 of 50 mm.

It is noted that the size of the ROM material may be larger or smaller than the above-described size ranges.

The ROM material may be any suitable shape, noting that size ranges described in the preceding paragraph are based on one dimension only.

The method may comprise selecting a mining method to form the ROM material in a suitable form, including size distribution and/or shape, for the heap leaching step.

The mining method may include open pit mining methods that produce ROM material.

The open pit mining methods may include drilling and blasting blocks of material, with blasted rocks slumping into the pit as ROM material and being transported by haul trucks or other suitable vehicles or conveyors from the pit.

The mining method may include underground mining methods that produce ROM material.

The underground mining methods may include block cave mining, sub-level cave mining, or any other suitable underground mining methods, with material being removed from extraction points, such as draw points in block cave mines, as ROM material and being transported by haul trucks or other suitable vehicles or conveyors to above-ground.

The mining method may include breaking rocks of ROM material that are too large to be transported from mines into smaller rocks of ROM material, for example by rock breakers, as described herein.

The mining method may include separating ROM material on the basis of size, for example via screens, into different size fractions of the ROM material. The size-separated material is within the definition of ROM material.

The present invention also provides a method of heap leaching copper from a run-of-mine (“ROM”) material from a mine that contains a copper sulfide-containing material comprises:
(a) forming a heap of the ROM material or extending an existing heap by adding the ROM material to the heap;
(b) adding additional material (additives) to the heap that comes from one or more than one or all of the following:
   i. additional pyrite to that in the ROM material;
   ii. silver;
   iii. an activation agent to activate the added silver or natural silver in the ROM material;
   iv. a complexing agent to enhance the dissolution of the copper sulfide in the ROM material by forming complexes between (a) sulfur, that originated from the copper sulfide-containing material in the ROM material and (b) the complexing agent, and
   v. chlorides; and
(c) leaching copper from the ROM material in the heap with an acidic leach liquor.

The present invention also provides a method of heap leaching copper from a run-of-mine (ROM) material from a mine that contains a copper sulfide-containing material comprises:
(a) mining a ROM material;
(b) adding additional material (additives) to the ROM material that comes from one or more than one or all of the following:
   i. additional pyrite to that in the ROM material;
   ii. silver;
   iii. an activation agent to activate the added silver or natural silver in the ROM material;
   iv. a complexing agent to enhance the dissolution of the copper sulfide in the ROM material by forming complexes between (a) sulfur, that originated from the copper sulfide-containing material in the ROM material and (b) the complexing agent, and
   v. chlorides;
(c) forming a heap of the ROM material; and
(d) leaching copper from the ROM material in the heap with an acidic leach liquor.

The method defined may comprise adding additional additives to the ROM material in or at any one or more of:
(a) a location at which the ROM material forms in a mining operation (for example slumped material that forms after a mine bench is drilled and blasted),
(b) a location where ROM material is loaded onto haul vehicles (such as haul trucks or load-haul-dump vehicles) or conveyors or any other transport options, with additional pyrite being added with or after the ROM material is add onto the transport options,
(c) as the ROM material is being transported from a loading location(s) in the mine to a heap, a stockpile, or an intermediary station, or from the stockpile or the intermediary station to the heap,
(d) as the ROM material is being added to the heap,
(e) at an intermediary station located between the loading location(s) and the heap,
(f) at an intermediary station located between the stockpile and the heap,
(g) in a blending operation comprising blending together the ROM material and additional pyrite and then adding the blend to the heap,
(h) in the stockpile, and
(i) in the heap, for example in the leach liquor or directly as a separate additive as the heap is being formed or after the heap has been formed, such as to a top of the heap during the course of the heap leaching step.

The present invention also provides a heap leaching operation for leaching a metal from a run-of-mine (ROM) material containing a metal sulfide-containing material, such as a metal sulfide mineral, in accordance with the above-described heap leaching method, the heap leaching operation comprising:
(a) a heap of the ROM material and additional pyrite; and
(b) a system that (i) supplies an acidic leach liquor and microbes to the heap so that the leach liquor flows downwardly though the heap and leaches the metal from the material and (ii) collects a pregnant leach liquor containing the metal in solution from the heap, with the pyrite generating acid and heat in the heap that facilitates leaching the metal from the ROM material, and with the microbes oxidising ferrous ions and oxidising solid and soluble sulfur compounds, thereby regenerating ferric ions and acid and generating heat.

In broad terms, the invention also provides a method of mining a run-of-mine (ROM) material and heap leaching the ROM material comprising:
(a) mining a material containing a metal sulfide-containing material and forming ROM material; and
(b) the above-described heap leaching method.

The above-described heap leaching method, heap leaching operation, and mining method have the following advantages:
Heap leaching ROM material facilitates comparatively quick heap construction and therefore minimises the time delay to generating a cash flow.
The method makes it possible to extract a metal such as copper or nickel or zinc or cobalt from a metal sulfide-containing material material that has been categorized by a mine operator as being “non-economic” from the perspective of recovering the metal from the material.
When any additional pyrite is sourced from the (or another) mine, such as a tailings facility of the mine, the method makes it possible to process tailings that contain pyrite and thereby reduce the volumes of existing tailings dams. This is an important environmental outcome.
The acid and heat generating capacity of pyrite (whether already in the ROM material or as additional pyrite) is an advantage in heap leaching and, for example, can reduce the amount of added acid that is required in the leach liquor.
Moreover, the acid-generating capacity of pyrite means that any additional pyrite is used beneficially in the leach step and results in a net reduction in pyrite, which is significant from an environmental perspective.
The method can be operated with readily available and tried and tested equipment.
The method makes it possible to process what has been previously classified as “waste” metal, such as copper, sulfide-containing material and reduce the environmental impact of these materials as well as optimising the recovery of value from the ROM material.

### BRIEF DESCRIPTION OF THE DRAWING

The invention is described further below by way of example only with reference to the following Figures, of which:

FIG. 1 is a flow sheet of one embodiment of a method of heap leaching a copper sulfide-containing material in accordance with the invention;

FIG. 2 is a flow sheet of another embodiment of a method of heap leaching a copper sulfide-containing material in accordance with the invention; and

FIGS. 3-5 are graphs indicating the results of experimental work in relation to a generic method of heap leaching a copper sulfide-containing material in accordance with the invention.

### DETAILED DESCRIPTION OF FIGURES

The invention is generally directed towards recovering copper from a ROM material that contains copper sulfide-containing material, specifically copper sulfide minerals, such as chalcopyrite, that is formed in a mining operation.

It is noted that, as described above, the term “mining operation” covers above ground and underground mines that produce ROM material to be transported from the mines to downstream plants to process the material and ultimately recover copper from the material.

It is noted that the invention is not confined to copper and extends to other metals such as nickel or zinc or cobalt, in metal sulfide-containing materials, such as metal sulfide minerals, in a material.

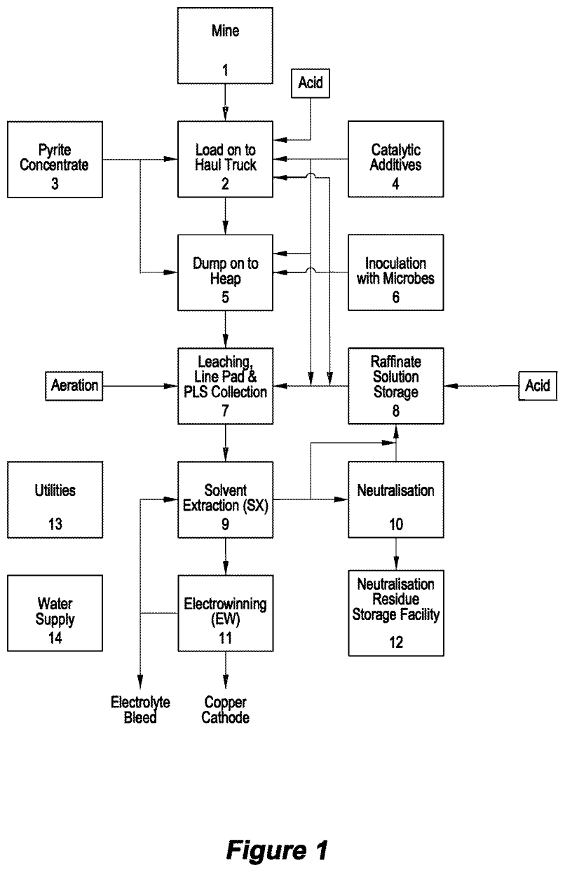

The embodiments of the invention described below in relation to FIGS. 1-5 are based on microbial-assisted heap leaching ROM materials with selected additives (described below) for time periods of up to 35-40 years. The invention is not limited to microbial-assisted heap leaching and to this time period.

In general terms, each embodiment shown in Figures land 2 is a method of mining a material and recovering copper from copper sulfide minerals in the ROM material, comprising:
(a) mining and optionally stockpiling a ROM material containing copper sulfide minerals (such as chalcopyrite);
(b) forming a heap of the ROM material or extending an existing heap by forming a new lift or increasing the length and/or width dimensions of the existing heap by adding the ROM material, which ROM material may optionally have added thereto pyrite in a concentrate or other suitable form (or any other form of additional pyrite to that in the ROM material) when additional pyrite in ROM material is required;
(c) leaching copper from the ROM material in the heap with an acidic leach liquor and microbes;
(d) optionally enhancing copper extraction from the ROM material with one or more than one other additives, in addition to the optionally added pyrite, such as silver, silver activation agents, complexing agents, and chlorides described further below, added to the ROM material before the heap is formed, as the heap is being formed, or after the heap has been formed;
(e) recovering a pregnant leach liquor containing copper in solution from the heap;
(f) recovering copper from the pregnant leach liquor via a solvent extraction system; and
(g) regenerating a raffinate produced when copper is recovered from the pregnant leach liquor in the solvent extraction system and transferring the raffinate to the heap as the leach liquor.

Typically, the ROM material has a low copper grade of ≤0.9 wt. %, typically ≤0.8 wt. %, more typically ≤0.7 wt. %, more typically ≤0.5 wt. %, even more typically ≤0.3 wt. %, even more typically ≤0.1 wt. %. The invention also extends to ROM materials having higher copper concentrations.

In addition, the embodiments of the method of recovering copper from ROM material containing copper sulfide-containing material, specifically copper sulfide minerals, such as chalcopyrite, in accordance with the invention shown in FIGS. 1-5 are described in the context of the pyrite being a pyrite concentrate extracted from mine tailings. The invention extends to other forms of additional pyrite.

It is understood that the invention is not confined to these embodiments and extends generally to any suitable copper-containing material and to any suitable source of pyrite.

The extraction of copper from ROM materials containing copper sulfide minerals, such as chalcopyrite, requires an oxidant and an acid.

In the Examples below, ferric ions are used as an oxidant, and sulfuric acid is used as an acid. During the process of mineral dissolution, ferric ions are reduced to ferrous ions and sulfuric acid is consumed during reactions with gangue minerals.

Microorganisms oxidise ferrous ions, regenerating ferric ions, as well as oxidising solid and soluble sulfur compounds, generating sulfuric acid and heat.

Maintaining sufficient rates of iron and sulfur oxidation to facilitate optimal copper extraction requires a microbial population supplied with an inhabitable environment and any required nutrients.

The mechanisms of dissolution of copper sulfide minerals in ROM materials depend on the presence of ferric ions and acid to break down the mineral matrix and solubilise metals. Ferric ions and acid are consumed during mineral oxidation, and dissolution rates will decrease unless they are replenished.

Under aerobic conditions, microbes (such as acidophilic bacteria and archaea, more particularly such as members of the bacterial genera Acidithiobacillus, Leptospirillum and Sulfobacillus and members of archaeal genera Acidianus, Acidiplasma, Ferroplasma, Metallosphaera, Sulfolobaceae and Thermoplasma) regenerate ferric ions and acid through biological oxidation of ferrous ions (such as from pyrite FeS2 or chalcopyrite CuFeS2) and sulfur compounds (including elemental sulfur), as follows:

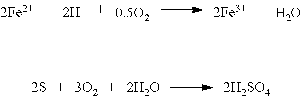

The sulfur compounds may be derived from oxidation of sulfide minerals (such as pyrite) or as an addition (such as elemental sulfur) from any source, such as cleaner scavenger tails from a concentrator circuit. The sulfur compounds may be sulfur-containing inorganic compounds such as thiosulfate or polythionates or polysulfides, or sulfur-containing organic compounds such as thiourea or other thiocarbamides.

Not only do these reactions maintain concentrations of ferric ions and acid, they also generate energy, potentially making the process autocatalytic under conditions ideal for microbial reproduction.

During mineral dissolution of copper sulfide minerals in ROM materials, changing solution conditions impact the activity of microbes present in the leaching environment.

The applicant has found that the rate of ferrous ion and sulfur oxidation is affected by high metal concentrations, fluctuations in solution pH and changes in temperature. Sulfide mineral dissolution (and therefore copper extraction of copper sulfide minerals in ROM materials can be negatively impacted if ferric ions and acid are not regenerated through microbial activity at a sufficient rate.

### Embodiment 1—FIG. 1

An embodiment of a method of heap leaching a copper sulfide-containing ROM material in accordance with the invention is described with reference to FIG. 1.

ROM material is formed in a mining operation in a mine 1 and loaded onto haul trucks 2 (or other suitable vehicles) in the mine and transported from the mine to a heap location to form a heap 5.

The transportation of the ROM material from the mine 1 to the heap location may include one or more intermediate stops at a stockpile or an intermediary station.

In some situations, the ROM material may be stored at a stockpile or the intermediary station for a significant period of time before ultimately arriving at the heap.

The term “significant period of time” is intended to encompass the time periods in which waste rock stockpiles are stored at a mine site until such time that the waste rock can be economically processed to recover metal from the material. The time period may be measured in years, decades or longer.

It is noted that the invention also extends to ROM material that has been subjected to rock breaking of larger rocks of ROM material and/or size separation of ROM material into different-sized fractions,

Screening ROM material is one example of a size separation option.

In both cases where there has been rock breaking and/or size separation, the resultant material is within the definition of ROM material.

The heap 5 may be a new heap, with the ROM material being used to construct the heap 5.

The heap 5 may be an existing heap, with the ROM material being used to create a new vertical lift or to extend the length and/or width dimensions of the heap 5.

The heap may be of any suitable construction.

By way of example, the heap 5 may include:
(a) a leach liquor storage and delivery system 8 to supply the leach liquor, which is essentially a raffinate, to an upper surface of the heap so that the leach liquor can percolate through the heap and solubilise copper in the heap;
(b) an outer cover (not shown), such as a thermofilm, for at least the sides of the heap to assist in temperature control in the heap;
(c) an aeration system 7 for example comprising a blower and pipework for supplying air from the blower to the interior of the heap;
(d) a pregnant leach liquor collection system (not shown) for collecting leach liquor containing copper in solution that is extracted from copper sulfide-containing materials in the heap; and
(e) microbes other suitable oxidants for oxidising ferrous ions and oxidising solid and soluble sulfur compounds, thereby regenerating ferric ions and acid and generating heat, produced in a microbe generation unit 6.

When additional pyrite over and above that already in the ROM material is required, a predetermined amount of a pyrite concentrate 3 (or other suitable form of pyrite) is added to the ROM material. Addition of such additional pyrite may occur where the ROM material is formed, at a location(s) where the ROM material is loaded onto haul trucks 2 (or other suitable vehicles or transport options including conveyors), as the ROM material is being transported from the loading location(s), at a stockpile or other intermediary station between the loading location(s) and the heap, and/or the heap 5, including on the heap. For example, the pyrite concentrate 3 (or other suitable form of pyrite) may be added to the haul trucks 2 as they are transporting the ROM material and/or the heap 5. The amount of the pyrite concentrate 3, if required, is determined in any given situation, including during the course of the heap leaching step (b), having regard to a range of parameters including, but not limited to, the concentration of pyrite in the pyrite concentrate 3, the amount of pyrite in the ROM material, the mineralogy of the ROM material, a target copper extraction rate, a target heap temperature, a target ramp-up time to the target heap temperature, the leach conditions, including En of the acidic leach liquor and/or the irrigation rate, the type and population of microbes in the heap, and other additives 4 (described below) added to the ROM material where the ROM material is formed, at a location(s) where the ROM material is loaded onto haul trucks 2 (or other suitable vehicles or transport options including conveyors), as the ROM material is being transported from the loading location(s) and the heap 5, including on the heap. The assessment may include monitoring any one or more than one of the parameters mentioned above.

A predetermined population of microbes produced in a microbe generation unit 6 is added to the ROM material in the haul trucks 2 or in the heap 5 or in the leach liquor for the heap 5, including during the course of the heap leaching step (b). The population required in any given situation is determined having regard to the parameters described in the preceding paragraph. The selection of the location of the addition of microbes can be determined having regard to assessment of operating conditions during the course of heap leaching ROM material. The assessment may include monitoring any one or more than one of the parameters mentioned above.

The microbes may be generated in any suitable microbe generation unit 6. In one embodiment the microbe generation unit 6 comprises a series of linked, stirred, tanks. Air, acid, and water are supplied, as required, to the tanks. In addition, iron-containing sulfide minerals (such as pyrite) in tails from a cleaner scavenger unit of a concentrator circuit (not shown) in the mine are supplied to the tanks. It is noted that the iron-containing sulfide minerals (such as pyrite) may be obtained from any suitable source.

Optionally, predetermined amounts of one or more than one other additives, collectively referred to as the catalytic additives 4 in FIG. 1, such as silver, silver activation agents, and complexing agents (such as salts, such as chlorides), for enhancing copper extraction from the ROM material may be added as described below.

A predetermined addition of silver 4, for example in the form of silver chloride, silver nitrate or silver sulfate may be added to the ROM material. This is an optional addition because there may be sufficient silver in the ROM material. The selection of the location of the addition of silver 4 can be determined having regard to assessment of operating conditions during the course of heap leaching ROM material. The assessment may include monitoring any one or more than one of the parameters mentioned above. As noted above, International Applications PCT/AU2016/051024 (WO2017/070747) and PCT/AU2018/050316 (WO 2018/184071) disclose the impact of silver augmentation on bioleaching of an agglomerated copper-containing ROM material.

In addition, a predetermined addition of an activation agent 4 to activate silver, for example selected from thiourea, chlorides, bromides and iodides may be added to the ROM material. The selection of the location of the addition of the activation agent can be determined having regard to assessment of operating conditions during the course of heap leaching ROM material. The assessment may include monitoring any one or more than one of the parameters mentioned above. As noted above, International Application PCT/AU2018/050316 (WO 2018/184071 discloses activation agents that activate silver whereby the silver enhances copper extraction from copper materials.

Further, a predetermined addition of additives 4, such as thiourea and carbamide phosphate (as disclosed in U.S. Pat. No. 3,679,397), that form complexes between (a) sulfur, that originated from copper minerals in the materials, and (b) the additives, may be added to the ROM material in the haul trucks 2 or to the heap 5 or in the leach liquor for the heap, including during the course of the heap leaching step (b). The selection of the location of the addition of such additives can be determined having regard to assessment of operating conditions during the course of heap leaching ROM material. The assessment may include monitoring any one or more than one of the parameters mentioned above. As noted above, International Application PCT/AU2019/050383 (WO2019/213694) discloses the impact on the dissolution of copper from copper minerals in materials or concentrates of materials of such additives.

Further, a predetermined addition of additives 4 in the form of chlorides (or other salts) may be added to the ROM material. The selection of the location of the addition of the chlorides can be determined having regard to assessment of operating conditions during the course of heap leaching ROM material. The assessment may include monitoring any one or more than one of the parameters mentioned above. Typically, the chlorides are added to the leach liquor, which is essentially a raffinate. Typically, the chlorides are added to the leach liquor in an amount so that the total chlorides in the leach liquor are up to 10 g/l suitably up to 4 g/l. As noted above, the term “total chlorides” is a total of the chlorides that are already in the leach liquor and the additional chlorides added to the leach liquor.

A predetermined amount of a suitable acid, such as sulfuric acid, may also added to the ROM material. The selection of the location of the acid addition and the dose rate can be determined having regard to assessment of operating conditions during the course of heap leaching ROM material. The assessment may include monitoring any one or more than one of the parameters mentioned above.

The additional microbes, silver, activation agent and sulfuric acid and other of the above mentioned additives may be added to the ROM material where the ROM material is formed, at a location(s) where the ROM material is loaded onto haul trucks 2 (or other suitable vehicles or transport options including conveyors), as the ROM material is being transported from the loading location(s) and the heap 5, including on the heap, in the leach liquor for the heap (with the leach liquor essentially being a raffinate supplied from the leach liquor storage and delivery system 8), including during the course of the heap leaching step (b).

The pregnant leach liquor from the heap 5 is processed in a solvent extraction system 9 that extracts copper from the liquor in an organic medium (solvent) and then strips copper from the organic medium and produces a copper-containing solution. The invention extends to any suitable copper recovery systems.

The copper-containing solution is transferred to an electrowinning plant 11 and copper is recovered from solution.

A raffinate from the solvent extraction system 9 is regenerated and transferred to the leach liquor storage and delivery system 8 and returned to the heap as leach liquor. Make-up acid is also added to the leach liquor storage and delivery system 8, as required.

The leach liquor regeneration system includes a raffinate bleed limestone/lime neutralization 10 to control the build-up of impurities, generating neutralized solids for separate impoundment or possibly co-impoundment with tailings.

The pyrite-containing concentrate that is in the heap 5 provides valuable sources of (a) acid via the pyrite and (b) heat in the heap 5.

The acid-generating properties of the pyrite mean that the amount of acid that has to be added to the leach liquor can be reduced to maintain a given leaching acid requirement.

As noted above, the pyrite may be sourced from a mine tailing.

This option is described in the above-mentioned International Applications PCT/US2021/043869 (WO 2022/026810) and PCT/US2021/043869 (WO 2022/026826), and the disclosure in these International Applications is incorporated herein by cross-reference.

For example, the pyrite may be in tailings from a tailings dam or a material processing plant (such as cleaner scavenger tails from a concentrator circuit) of the mine or another mine. By way of further example, the pyrite may be obtained as a pyrite concentrate by removing pyrite from a pyrite-containing slurry from a tailings dam or a material processing plant of the mine.

The pyrite removal step may include floating pyrite-containing particles in the pyrite-containing slurry and producing (i) an inert stream as one flotation output and (ii) a pyrite-containing material stream, such as a pyrite-containing concentrate stream, as another flotation output.

The pyrite removal step may include, before the above flotation step, a size separation step, such as via cyclones or other suitable classification devices, that for example separates larger particles from the pyrite-containing slurry, with the remaining pyrite-containing slurry being transferred to the flotation step.

The pyrite removal step may include reducing the size of the larger particles in a size reduction circuit and returning the reduced-sized particles to the size separation step.

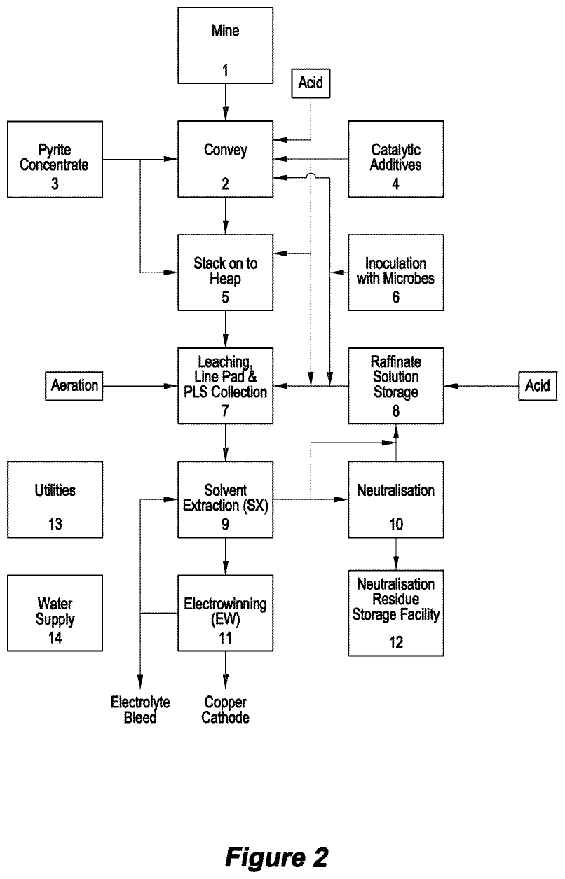

### Embodiment—FIG. 2

The embodiment described in relation to FIG. 2 is substantially the same as the embodiment described in relation to FIG. 1 and the same reference numerals are used for both Figures.

The only difference between the embodiments is that the FIG. 2 embodiment uses a conveyor system to transport ROM material from the mine 1 to a heap 5 and a material stacking system (not shown) to distribute ROM material onto the heap 5. Otherwise, the embodiments are the same, with the same other unit operations and processing steps.

The FIG. 2 embodiment is particularly suitable for situations in which the ROM material from the mine 1 has a size range that is not too large and can be transported on the conveyor system.

The use of the conveyor system presents opportunities for the addition of additives, such as pyrites and other additives mentioned above.

For example, there may be additive addition stations located along the length of a conveyor.

For example, there may be additive addition stations at an entry end and/or a discharge end of a conveyor.

### Advantages of the Embodiments Shown in FIGS. 1 and 2

The advantages of the above-described embodiments, and the invention generally, include the following advantages:
Heap leaching ROM material facilitates comparatively quick heap construction and therefore minimises the time delay to generating a cash flow.
The method makes it possible to achieve economic extraction of a metal such as copper or nickel or zinc or cobalt from a mined material that has been categorized by a mine operator as being “non-economic”. This is achieved through increase extraction and recovery rates by way of the aforementioned additives and microbes, as well as reduced OPEX by way of applying the method to ROM material that is subject to minimal processing.
The method makes it possible to reduce OPEX by heap leaching a ROM material instead of crushed-agglomerated material, thereby providing opportunities for improving overall economics.
When any additional pyrite is sourced from the (or another) mine, the method makes it possible to process tailings that contain pyrite and thereby reduce the volumes of existing tailings dams. This is an important environmental outcome.
The acid and heat generating capacity of pyrite (whether already in the ROM material or as additional pyrite) is an advantage in heap leaching and, for example, can reduce the amount of added acid that is required in the leach liquor.
Moreover, the acid-generating capacity of pyrite means that any additional pyrite is used beneficially in the leach step and results in a net reduction in pyrite, which is significant from an environmental perspective.
The method can be operated with readily available and tried and tested equipment.
The method makes it possible to process what has been previously classified as “waste” material and reduce the environmental impact of these materials as well as optimising the recovery of value from the mine.

### Heap Leaching Methodology—FIGS. 1 and 2

The above description of the embodiments shown in Figures land 2 provides details of the unit operations in the embodiments and the methodology for operating the embodiments.

The viability of heap leaching ROM material sourced directly from a mine or via a stockpile has been established in the modelling work described below.

The results of the modelling work provide a basis for a mine operator to establish target operating conditions for a heap leach operation in any given situations and operating procedures to start up heap leaching operations quickly and to maintain operations of the heaps during the life of the heaps.

In relation to start-up, the method may include selecting the amount of the additional pyrite in the heap and the type of pyrite addition (such as selecting fine-sized pyrite concentrates) to optimize heat generation in the heap.

In relation to start-up, the method may also include selecting the amount and type of other additives in the heap.

The target heap conditions in any given situation will be a function of a number of parameters, including material mineralogy, climate conditions, microbes, acid selection, the selection, availability and cost of additives (such as additional pyrite, silver, activation agents for silver, and complexing agents and chlorides described above), target copper extraction rate, and economic factors such as operating costs including reagent costs.

After the heap reaches a target temperature (determined having regard to the selection of operating parameters such as microbes, material mineralogy, leach liquor, and other factors), the method comprises monitoring heap parameters selected from any one or more than one of heap temperature, leach liquor irrigation rate, aeration rate, pH of the leach liquor, En of the leach liquor, the population of microbes, other additive selections and addition rates, copper extraction rate, etc., and adjusting any one or more than one of the parameters to maintain target heap conditions.

Adjustments to heap parameters will inevitably be necessary with changes in mineralogy and size of ROM material and climate changes, etc.

The required adjustments can be determined for example by operator judgment having regard to reviewing the monitored parameters, and the adjustments may be made for example by adjusting irrigation rates, aeration rates, pyrite and other additive addition rates.

The required adjustments can be determined for example by automated control to bring heap conditions to set points established prior at heap start-up having regard to modelling work for the heap. Again, the adjustments may be made for example by adjusting irrigation rates, aeration rates, pyrite and other additive addition rates.

The required adjustments can be determined for example by automated control to bring heap conditions to optimal conditions via direct reference to the model for the heap. Again, the adjustments may be made for example by adjusting irrigation rates, aeration rates, pyrite and other additive addition rates.

### Modelling

### Modelling Work

The applicant has carried out computational fluid dynamics (“CFD”) modelling work on a generic heap of ROM material, to assess the invention. The applicant modelled a series of scenarios with and without “additives” considered by the applicant to be important to heap leaching performance.

### Generic Heap

The generic heap was created by the applicant from:
Publicly available information.
Information averaged across a range of samples.
Learnings of the applicant from the research and development project described above, including the learnings reported in the above International Applications.
Learnings of the applicant from a CuPER model developed by the applicant.
Standard/industry practice parameters.

The applicant did not rely on confidential information of the applicant that is outside the research and development project.

The CuPER model used by the applicant is a confidential model of the applicant.

### Assumptions for the CFD Model

~45 Mtpa heap.
Located in the Atacama desert.
   assumed weather conditions for this location.
ROM material having a P80 of 40 mm.
Multiple lifts.
Each lift having an 18 m lift height.
7 lifts.
A new lift stacked every month (30 days) and leached for 1 year (360 days).
The bottom lift received 7 years total leaching (2520 days).
Quick progression to each successive lift.
The heap was constructed (physical features) and operated (additives such as pyrite) to maintain heap temperature.
   For example, the sides of the heap were completely covered in a thermofilm to minimise heat loss.
Constant mineralogy of ROM material.
Average of samples having 0.41% CuT, with 74% of the copper as chalcopyrite.
Average of samples having 2.64% pyrite.
Microbes in appropriate quantities.

### Scenarios

The CFD modelling evaluated the following scenarios:
1. Base case
   No additives (including no chloride in solution, due to host rock)
2. Silver+chloride
   0.25 g Ag/kg Cu.
   1 g/L chloride.
3. Pyrite concentrate.
   1% pyrite concentrate augmentation.
4. Thiourea
5. Pyrite concentrate+silver+chloride
   1% pyrite augmentation.
   0.25 g Ag/kg Cu.
   1 g/L chloride.

### CFD Modelling Approach

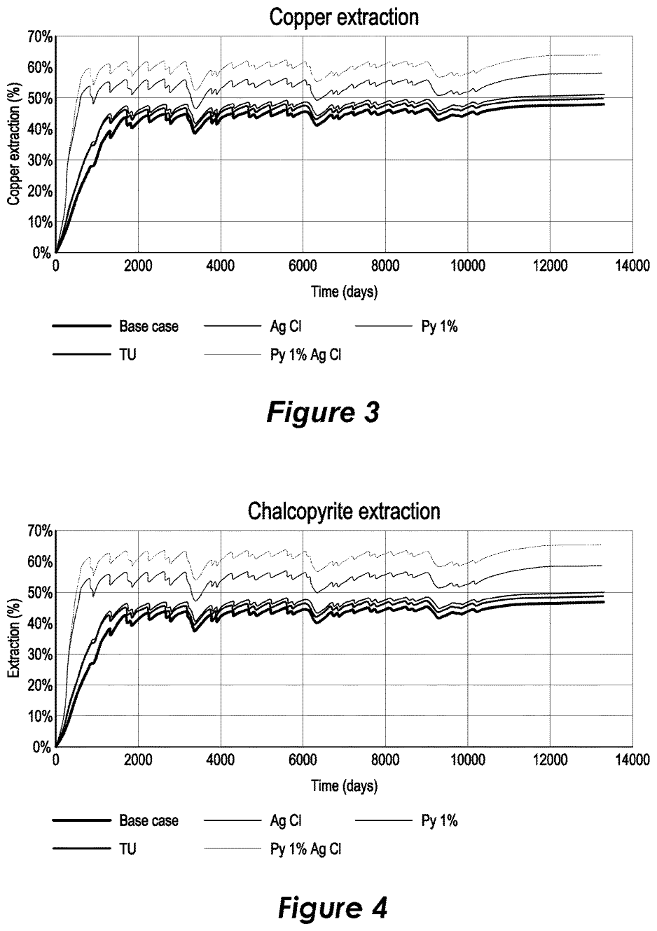

Results shown in FIGS. 3-7 are CFD modelling outputs for the above-described generic heap.
CFD model assumptions were obtained from CuPER modelling carried out by the applicant. Specifically, the applicant relied on:
   CuPER modelling of generic material, leached for 7 years (equivalent to the bottom lift of the heap) used as inputs to the CFD model.
   CuPER outcomes of rate constants and chalcopyrite passivation used as inputs to the CFD model.
The scenarios were modelled as a newly-constructed and operated heap.
   Comparison of Results from the CFD and CuPER Models
The base case leach performance in the CFD model is better than that in the CuPER model.
   This could be related to the temperatures predicted by the CFD model.
The additive benefit calculated from the CFD model results is slightly less than that calculated from the CuPER model.
The broad trends are the same for the CFD and CuPER models.
There is a good confidence in the complementary use of the two-model approach.

### Results—FIGS. 3-5

The modelling results shown in FIGS. 3-58 are for Lift 1 (leached for a total of 7 years).
The results in FIGS. 3-5 support viability of a pyrite concentrate ROM heap.

### Discussion of the Results in FIGS. 3-5

### FIG. 3—Copper Extraction v Time

The graph focuses on total copper extraction v time.
Scenario 5 (pyrite concentrate+silver+chloride) resulted in the best copper extraction, with a quick ramp-up to high extractions.
There is a significant difference in copper extractions between Scenario 5 and Scenario 1 (base case), both in terms the actual extractions and the ramp-up times.
   For example, after 1000 days, the Scenario 5 copper extraction was at 60% and the Scenario 1 copper extraction was only 35%.
   By way of further example, from 2000 days onwards, the Scenario 5 copper extraction was at 60% and the Scenario 1 copper extraction was only 40-45%.
Scenario 3 (pyrite concentrate) resulted in the 2^{nd} best copper extraction, with a quick ramp-up to high extractions.

### FIG. 4—Chalcopyrite Extraction v Time

The graph focuses on chalcopyrite extraction v time.
The results follow closely the copper extraction v time plots in FIG. 3, indicating that heap leaching ROM material is effective for the difficult to leach chalcopyrite mineral.

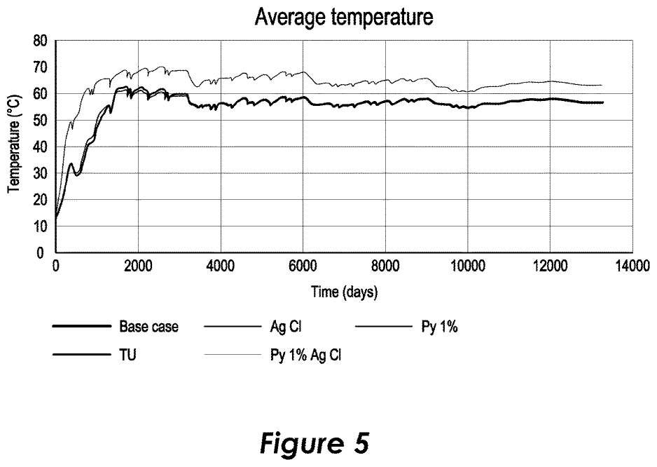

### FIG. 5—Average Temperature v Time

The graph focuses on average heap temperature v time.
Scenario 5 (pyrite concentrate+silver+chloride) resulted in the highest heap temperature, with a quick ramp-up to high extractions.
Note—The plots for Scenarios 1 (base) and 2 (silver+chloride) are in the Figure, although not clearly evident in the Figure. The reason for this is that three lower temperature Scenarios essentially overlap—i.e., Scenarios 1 (base), 2 (silver+chloride), and 4 (TU) and the two higher temperature Scenarios overlap—i.e., Scenarios 3 (pyrite concentrate) and 5 (pyrite concentrate+silver+chloride) overlap.

Many modifications may be made to the embodiments described in relation to FIGS. 1 and 2 without departing from the spirit and scope of the invention.

By way example, whilst the embodiments described in relation to FIGS. 1 and 2 include sourcing pyrite concentrate from a mine tailing as described in the above-mentioned International Applications PCT/US2021/043869 (WO 2022/026810) and PCT/US2021/043869 (WO 2022/026826), the invention is not limited to this option and extends to the use of any suitable source of pyrite.

By way of further example, whilst the embodiments described in relation to FIGS. 1-5 include the use of particular additives, such as silver, the invention is not limited to these additives and extends to any suitable additives.

1. A method of heap leaching a metal from a run-of-mine (“ROM”) material from a mine that contains a metal sulfide-containing material comprises:
(a) forming a heap of the ROM material or extending an existing heap by adding the ROM material to the heap; and
(b) leaching the metal from the ROM material in the heap with an acidic leach liquor, with pyrite already in the ROM material generating acid and heat that facilitates leaching the metal from the ROM material and producing a pregnant leach liquor containing the metal in solution.

2. (canceled)

3. (canceled)

4. The method defined in claim 1 comprises adding additional material (additives) to the ROM material before the heap is formed, as the heap is being formed, after the heap has been formed, or to the leach liquor.

5. The method defined in claim 4 wherein the additional material (additives) comprises pyrite.

6. The method defined in claim 5 comprises selecting the amount of additional pyrite for the heap to reach a target temperature quickly, i.e., in ≤500 days, more typically in ≤400 days, and more typically in ≤300 days.

7. The method defined in claim 5 wherein the target temperature, expressed as an average heap temperature, is in a range of 60-80° C.

8. The method defined in claim 5 wherein the additional pyrite and pyrite in the ROM material, i.e., total pyrite, is 1-10 wt. % of the total mass of the ROM material and the additional pyrite.

9. The method defined in claim 5 wherein the additional pyrite is a pyrite concentrate.

10. (canceled)

11. The method defined in claim 9 comprises sourcing the additional pyrite from tailings from a tailings dam or a material processing plant (such as cleaner scavenger tails from a concentrator circuit) of the mine or another mine.

12. The method defined in claim 5 comprises selecting the amount of the additional pyrite to be below a threshold total pyrite concentration for the pyrite in the ROM material and the additional pyrite.

13. The method defined in claim 4 wherein the additional material (additives) comprises microbes for oxidising ferrous ions and oxidising solid and soluble sulfur compounds, thereby regenerating ferric ions and acid and generating heat.

14. The method defined in claim 13 wherein, in a situation where the metal is copper, the additional material (additives) comprises silver.

15. The method defined in claim 13 wherein, in a situation where the metal is copper, the additional material (additives) comprises an activation agent to activate silver in the ROM material or added to the ROM material.

16. The method defined in claim 14 wherein, in a situation where the metal is copper, the additional material (additives) comprises a complexing agent to enhance the dissolution of copper by forming complexes between (a) sulfur, that originated from copper minerals in the ROM material, and (b) the complexing agent.

17. The method defined in claim 13 wherein, in a situation where the metal is copper, the additional material (additives) comprises chlorides.

18. The method defined in claim 17 wherein chlorides are added to the leach liquor, typically in an amount so that the total chlorides in the leach liquor are up to 4 g/l.

19. The method defined in claim 4 comprises adding the additional material (additives) to the ROM material in or at any one or more of:
(a) a location at which the ROM material forms in a mining operation (for example slumped material that forms after a mine bench is drilled and blasted),
(b) a location where ROM material is loaded onto haul vehicles (such as haul trucks or load-haul-dump vehicles) or conveyors or any other transport options, with additional material being added with or after the ROM material is add onto the transport options,
(c) as the ROM material is being transported from a loading location(s) in the mine to a heap, a stockpile, or an intermediary station, or from the stockpile or the intermediary station to the heap,
(d) as the ROM material is being added to the heap,
(e) at an intermediary station located between the loading location(s) and the heap,
(f) at an intermediary station located between the loading location(s) and the stockpile,
(g) at an intermediary station located between the stockpile and the heap,
(h) in a blending operation comprising blending together the ROM material and additional material and then adding the blend to the heap,
(i) in the stockpile, and
(j) in the heap, for example in the leach liquor or directly as a separate additive as the heap is being formed or after the heap has been formed, such as to a top of the heap during the course of the heap leaching step.

20. (canceled)

21. The method defined in claim 1 wherein heap leaching step (b) comprises supplying air to the heap via forced aeration.

22. The method defined in claim 1 wherein heap leaching step (b) comprises supplying air to the heap via natural circulation of air from outside the heap into the heap.

23. The method defined in claim 1 comprises monitoring heap parameters selected from any one or more than one of heap temperature, leach solution temperature, the leach liquor irrigation rate (including optional rest rinse cycles), aeration rate, pH of the leach solution, Eh of the leach liquor, the population of microbes, copper extraction rate, etc., and adjusting any one or more than one of the parameters to maintain target heap conditions.

24. (canceled)

25. (canceled)

26. (canceled)

27. (canceled)

28. (canceled)

29. A method of heap leaching copper from a ROM material from a mine that contains a copper sulfide-containing material comprises:
(a) forming a heap of the ROM material or extending an existing heap by adding the ROM material to the heap;
(b) adding additional material (additives) to the heap that comes from one or more than one or all of the following:
i. additional pyrite to that in the ROM material;
ii. silver;
iii. an activation agent to activate the added silver or natural silver in the ROM material;
iv. a complexing agent to enhance the dissolution of the copper sulfide in the ROM material by forming complexes between (a) sulfur, that originated from the copper sulfide-containing material in the ROM material and (b) the complexing agent, and
v. chlorides; and
(c) leaching copper from the ROM material in the heap with an acidic leach liquor.

30. (canceled)

31. (canceled)

32. (canceled)

33. (canceled)
